(19) United States
(12) Patent Application Publication
(10) Pub. No.: US 2011/0079332 A1
(43) Pub. Date: Apr. 7, 2011

(54) TIRE HAVING PVC IDENTIFIABLE ELEMENT ATTACHED TO A SURFACE THERETO

(75) Inventors: John P. Parla, Chestnut Hill, MA (US); Barry Liner, Needham, MA (US)

(73) Assignee: Tire Tatoo, Inc.

(21) Appl. No.: 12/871,424

(22) Filed: Aug. 30, 2010

Related U.S. Application Data
(60) Provisional application No. 61/275,544, filed on Aug. 31, 2009.

(51) Int. Cl. B60C 13/00; B29D 30/08

(52) U.S. Cl. 152/151; 156/110.1; 156/123

(57) ABSTRACT

A flexible polyvinyl chloride (PVC) molded element affixed to a sidewall of a tire. The PVC molded element includes a top surface with an exposed area, and a bottom surface including an area in contact with a surface portion of the tire sidewall. The PVC molded element can include at least one design and/or information molded into the top surface exposed area. The design can include logos, pictures, and shapes. The logos can include team logos for any professional or collegiate sports team. The information can include colors and text. The design and/or information can include 3-dimensional features. The PVC molded element bottom surface includes an adhesive having characteristics that will not degrade when in contact with the tire surface portion. The bottom layer may further include a primer to promote adhesion of the PVC molded element to the tire and/or a woven, mesh, or knit fabric.

### BACKGROUND

Tires are typically marked, in text or some other identifiable element, for identification purposes after the vulcanization of the tire. These marking are generally applied to the external surface or sidewall of the tire.

These markings can consist of a rigid element, a non-rigid element (e.g., tape), a layer of lacquer, a coat of paint, etc. The layer of lacquer and coat of paint are easily defaced or removed by scratching, rubbing, and the like. Both the rigid and non-rigid elements, on the other hand, resist following the local movement on the surface area of the tire during operation. As a result, it poses great difficulties to affix rigid and non-rigid elements to the external surface or sidewall of the tire for at least two reasons. First, the vulcanized compositions of diene rubbers, both natural and synthetic, act on the rigid and non-rigid elements and release plasticizers and other chemicals into the rigid and non-rigid elements. These plasticizers and other chemicals deteriorate the adhesive bond between the rigid and non-rigid elements and the tire, while also staining and discoloring the elements themselves. Second, the stresses that the tire is subjected while rolling cause significant deformations on the surface of the tire to which the rigid and non-rigid elements must be able to adapt. The mechanical properties of the non-rigid element cannot withstand the significant deformations on the surface of the tire without causing excessively great concentrations of stresses that results in a detachment or breakage of the non-rigid element.

### SUMMARY

A foam adhesive as been offered as the solution to these two problems for affixing a rigid element to the sidewall of a tire, however this solution is not satisfactory for improving the compromise between durable appearance and resistance to mechanical stresses for various weather conditions. For example, foam adhesives become rigid in cold weather conditions resulting in the incapability of the rigid element to follow the deformations of a tire without causing excessively great concentrations of stresses that results in a detachment or breakage of the rigid element from the tire.

Therefore, a need exists to provide a durable elements that can reduce or even prevent the plasticizers and other chemicals from degrading the adhesive between the element and the external surface of the tire, thereby impairing the color and/or the brightness of the element affixed to the external surface of a tire, while also providing the element the ability to accommodate deformations of the tire occurring in all weather conditions.

There is provided a tire including an internal surface and an external surface, the external surface having a tread and a sidewall. The tire includes at least one flexible polyvinyl chloride (PVC) molded element disposed entirely on a surface portion of the external surface, the PVC molded element further including a first surface in contact with air, and a second surface in contact with the tire surface portion. The bottom surface comprises an adhesive having characteristics that will not significantly degrade when in contact with the tire surface portion. The tire external surface can further include a primer to promote adhesion of the PVC molded element to the tire and/or a woven, mesh, or knit fabric.

The PVC molded element can include at least one design and/or information molded into the top element. The design can include logos, pictures, and shapes. The logos can include team logos for any professional or collegiate sports team. The information can include colors and text. The design and/or information can include 3-dimensional features. In some embodiment, the design and/or information can include a fluorescent material.

In some embodiments, the PVC molded element can be ultraviolet stable and will not fade when exposed to sunlight; abrasion resistant; and/or resistant to stains and commercial cleaning solvents. In some embodiments, the adhesive can resist the effects of plasticizer migration and/or oppose chemical migrations of the chemical composition components of the tire.

There is provided a method for affixing a PVC molded element to a sidewall of a tire, including cleaning the sidewall of the tire and applying an adhesive layer to a bottom surface of the PVC molded element. The step of cleaning the sidewall of the tire can optionally include applying an adhesive primer to the sidewall of the tire. The step of applying an adhesive layer of the PVC molded element to the tire may further include applying a transparent polyester film to a top surface of a PVC molded element. In some embodiments, the step of applying an adhesive layer of the PVC molded element to the tire can include applying firm pressure to the PVC molded element to develop a better adhesive contact and improve bond strength with the sidewall of the tire.

The embodiments provided herein provide the following advantages that withstand the harsh environments accorded on a tire. First, the use of a PVC molded element provides flexibility; ultraviolet stability; abrasion resistance; and stain and chemical solvent resistance. Second, the adhesive prevents plasticizer and chemical migration between the PVC molded element and the tire.

### BRIEF DESCRIPTION OF THE DRAWINGS

The foregoing and other objects, features and advantages will be apparent from the following more particular description of the embodiments, as illustrated in the accompanying drawings in which like reference characters refer to the same parts throughout the different views. The drawings are not necessarily to scale, emphasis instead being placed upon illustrating the principles of the embodiments.

FIG. 1 is a representation of a race car with advertisements or commercial messages affixed to its external surfaces;

FIG. 2 is a representation of some messages that are typically affixed to automobiles;

FIG. 3A is a schematic detailing the external surface of a tire;

FIG. 3B is a schematic detailing one embodiment of message affixed to the external surface of the tire of FIG. 3A;

FIG. 4A is one embodiment of a PVC molded element;

FIG. 4B is another embodiment of a PVC molded element;

FIGS. 5A-5E detail one embodiment of affixing the PVC molded element of FIG. 4A to a sidewall of a tire;

FIGS. 6A-6E detail one embodiment of affixing the PVC molded element of FIG. 4B to a sidewall of a tire; and

FIGS. 7A-7D are various examples of affixing the PVC molded elements to a sidewall of a tire.

### DETAILED DESCRIPTION

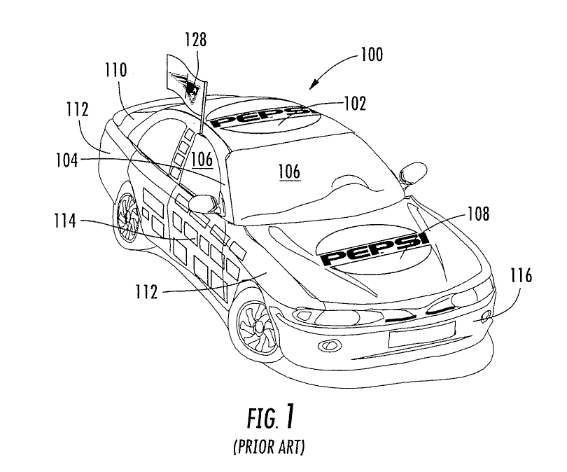

FIG. 1 is a representation of a race car 100 with advertisements or commercial messages affixed to its external surfaces. These surface areas include a roof 102, pillars 104, windows 106, a hood 108, a trunk 110, fenders 112, doors 114, and bumpers 116. In some instances, items are affixed to or extend from the windows 106, e.g. flags 128 or windsocks.

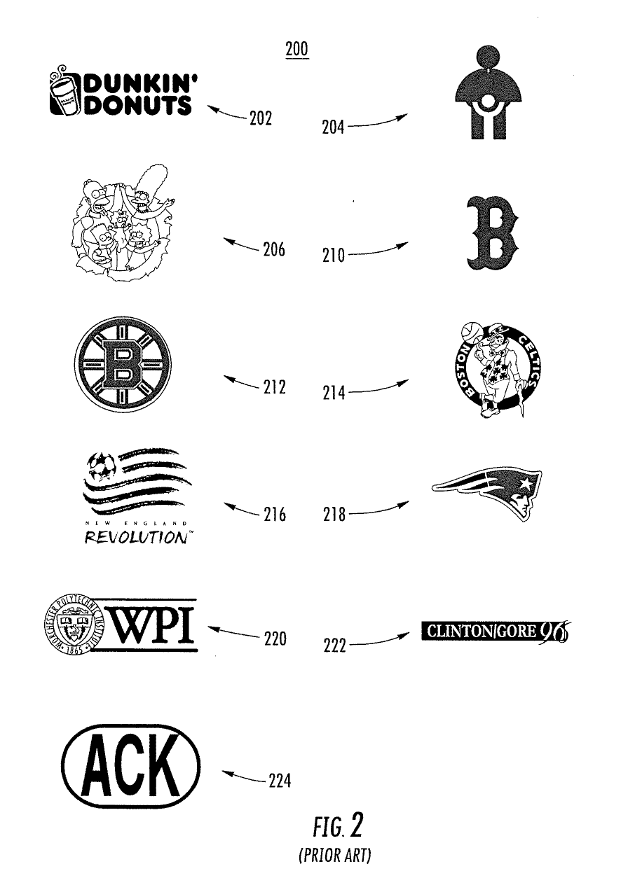

All external surfaces, with one exception, of personal automobiles to professional race cars (FIG. 1) have been used to display messages to be read by non-occupants of the vehicle. These messages are either painted, or affixed to the vehicle in the form of a sticker or decal. As shown in FIG. 2, these messages, collectively 200, can be commercial 202, religious 204, humorous 206, or in support of a sports team 210-218 or other organization 220. They may promote or oppose a particular philosophical or political position. These messages are a popular way of showing support for a candidate for a government seat 222 or in support of a political party (GOP). These messages can be a country (USA), state (MA), or city (MV) tag or code 224 (e.g., AUK). The one area not heretofore used for advertisements or messages has been the tires.

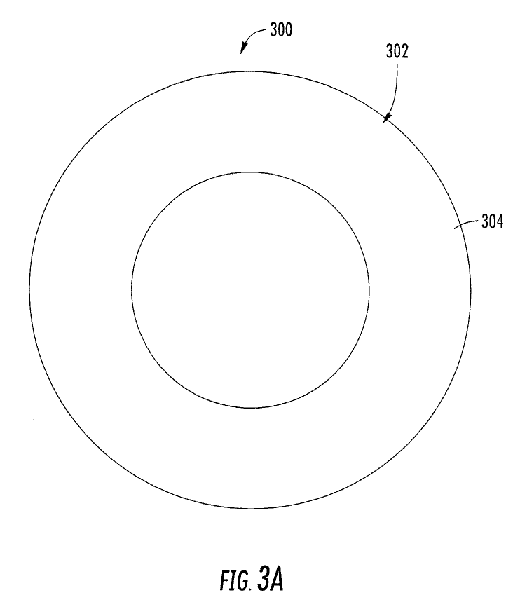

FIG. 3A is a schematic detailing the external surface of a tire 300. The external surface of the tire 300 includes a tread 302 and a sidewall 304. The sidewall 304 has a rubber composition that typically includes a saturated diene elastomer, at least one essentially unsaturated diene elastomer or a mixture of these two types of elastomers. The rubber composition can contain conventional additives and in particular agents for protection against ozone, oxidation, plasticizers, etc.

As shown in FIG. 3B, according to one embodiment, messages (e.g., 210, 212, 214, 222) can be affixed to the sidewall 304 of the tire 300. The composition of the sidewall 304 of the tire 300 contains at least one essentially saturated diene elastomer having plasticizers contained throughout.

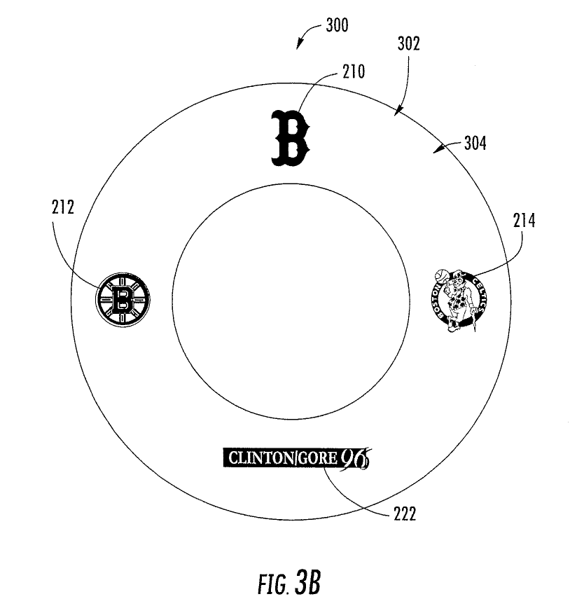

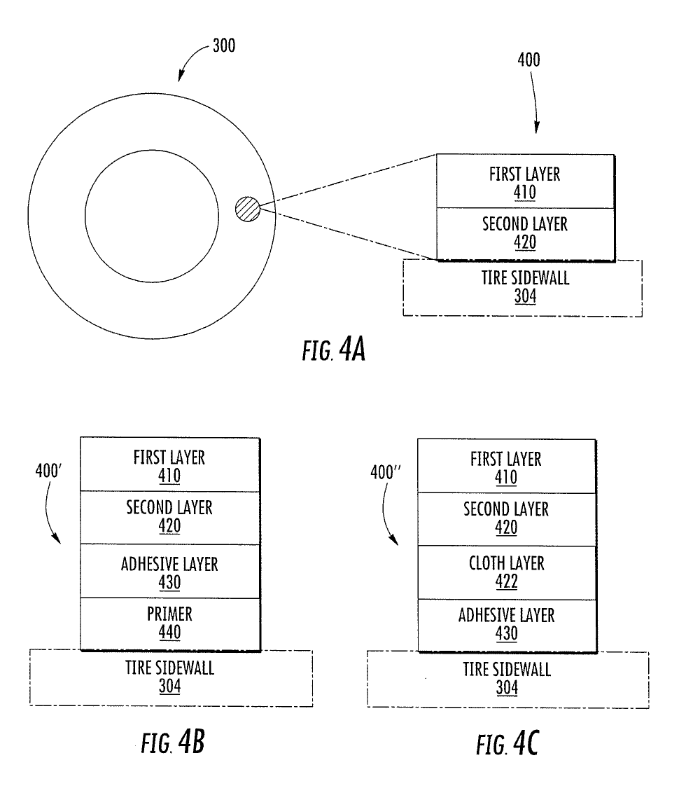

As shown in FIG. 4A, according to one embodiment, messages 200 are produced as a flexible polyvinyl chloride (PVC) molded element 400. The PVC molded element 400 includes a first or top surface 410 in contact with the air, a second or bottom surface comprising an adhesive layer 430. The adhesive layer 430 should be chosen to afford chemical and mechanical compatibility between the sidewall 304 of the tire 300 and the PVC molded element 400. That is, the adhesive should resist the effects of plasticizer migration of the PVC molded element 400 and should generally oppose migration of the chemical components of the tire 300. It has been found that one such adhesive works well for this purpose. The adhesive is Adhesive Transfer Tape F-9465PC made by 3M™. Additionally, the mechanical properties of the adhesive should include having sufficient flexibility as to not substantially impede flexing of the tire sidewall during operation. It should be understood that, once molded, the messages 200 can include at least one 2 or 3-dimensional design and/or contain 2 or 3-dimensional information. The designs can include logos, pictures, and shapes while the information can include colors and/or text. It also should be understood that the PVC molded element can be of any shape or size such that can fit within the area of the sidewall 304 of the tire 300.

As shown below, PVC is produced by polymerization of the vinyl chloride monomer (VCM).

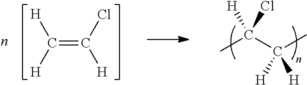

Before PVC can be made into the finished PVC molded element 400, additives such as heat stabilizers, UV stabilizers, lubricants, plasticizers, processing aids, impact modifiers, thermal modifiers, fillers, flame retardants, biocides, blowing agents and smoke suppressors, fluorescent material and, optionally pigments are incorporated into the PVC. The composition is then molded to produce the finished PVC molded element 400 containing the message 200.

By virtue of the additives, the PVC molded element 400 has the following advantageous properties. The PVC molded element 200 has sufficient flexibility as to not substantially impede flexing of the tire sidewall during operation. The PVC molded element 200 is ultraviolet stable and will not fade when exposed to sunlight. The PVC molded element 200 is abrasion resistant. The PVC molded element 200 is resistant to stains and cleaning solvents. These properties allow the PVC molded element 200 to last throughout harsh driving conditions accorded on the tire 300.

As shown in FIG. 4B, one embodiment of a PVC molded element 400′ further includes a primer layer 440. One primer found to work well with Adhesive Transfer Tape F-9465PC is also made by made by 3M™. It should be understood that other adhesives, in conjunction with primers, can be used that prevent plasticizer and chemical migration.

As shown in FIG. 4C, another embodiment of a PVC molded element 400″ further includes a cloth layer 422 and an adhesive layer 430. The cloth layer 422 can be a woven, mesh, or knit fabric. The adhesive layer 430 should be chosen to afford chemical and mechanical compatibility between the sidewall 304 of the tire 300 and the PVC molded element 400″. That is, the adhesive should resist the effects of plasticizer migration of the PVC molded element 400″ and should generally oppose migrations of the chemical components of the tire 300. It has been found that MXBON 606 adhesive made by Cartell™ works well for this purpose. It should be understood that other adhesives can be used that prevent plasticizer and chemical migration.

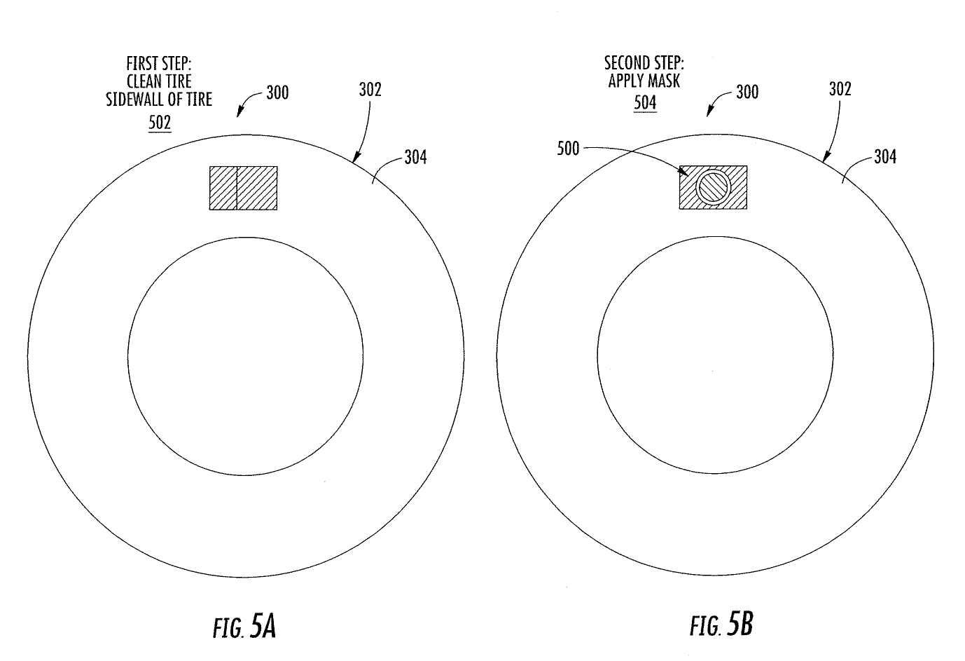

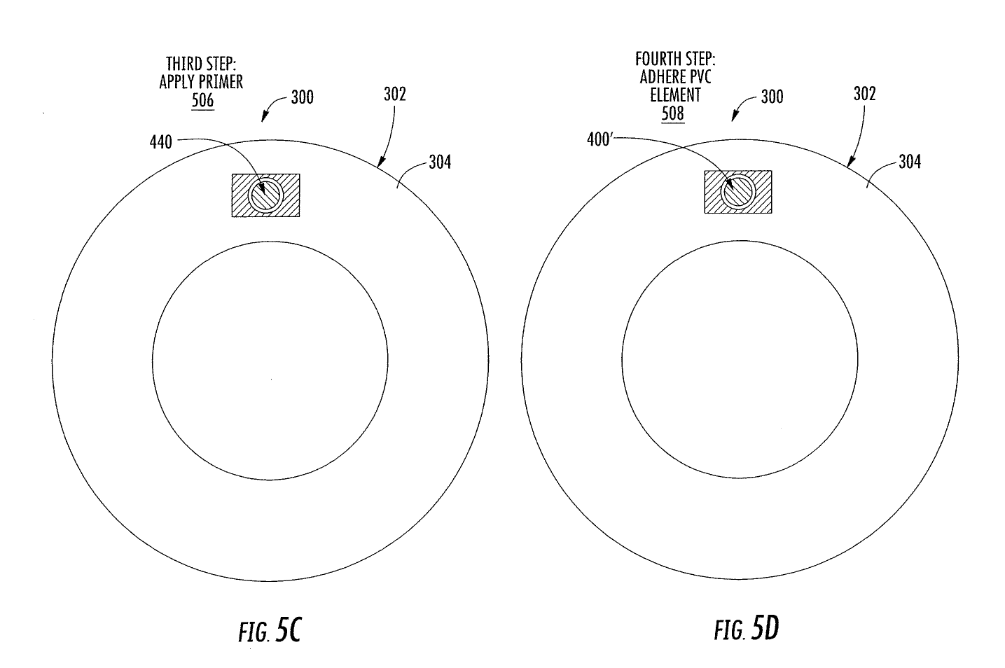

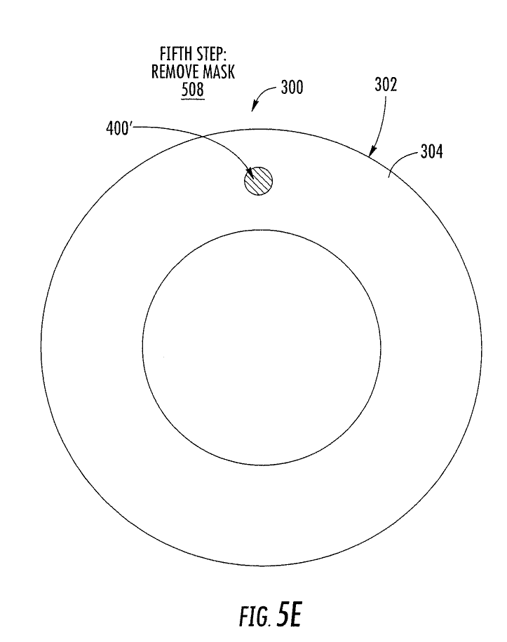

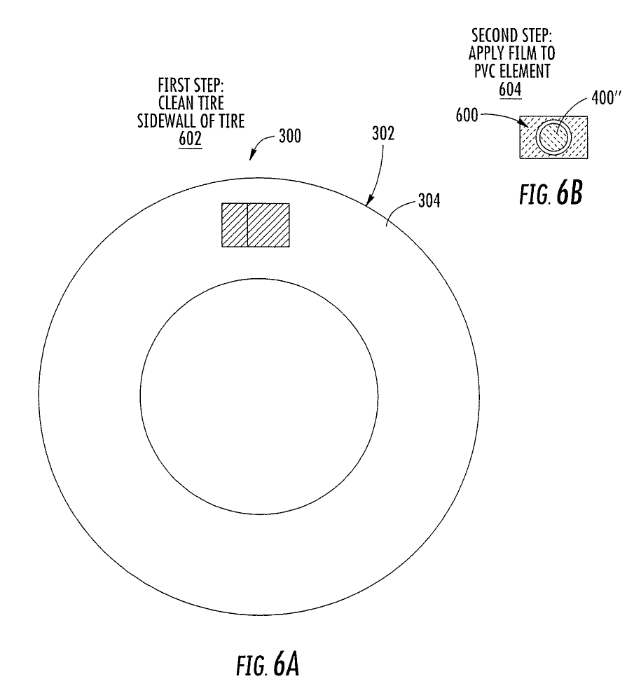

FIGS. 5A-5E illustrate affixing the PVC molded element 400′ to the sidewall 304 of the tire 300. First, the surface of the sidewall 304 of the tire should be cleaned, which may include lightly abrading the surface (Step 502). Optionally second, a mask 500 defining the PVC molded element 400′ may be temporarily affixed to the tire 300 (Step 504). Optionally third, a primer 440 is applied to the sidewall 304 of the tire 300 (Step 506). For this step (Step 506), mix the primer 440 well before using. Apply a thin uniform coating of the primer 440 to the sidewall 304 of the tire 300 using the minimum amount that will fully coat the bonding surface without dripping. Allow the primer 440 to dry thoroughly before applying the PVC molded element 400′, typically five (5) minutes at room temperature. Ensure that the primed surface remains clean prior to applying the PVC molded element 400′. The primer 440 may be applied with brush or swab, but can also be applied with a pressurized flow gun, knurled roller, or other suitable type of application equipment. Next, affix the adhesive layer 430 of the PVC molded element 440′ to the primed surface of the sidewall 304 of the tire 300 (Step 508). For this step (Step 508), apply firm pressure between the PVC molded element 400′ and the tire to ensure full adhesive contact thereby improving bond strength with the sidewall 304 of the tire 300. Next (Step 510), for applications using the optional mask 500, remove the mask from the sidewall 304 of the tire 300.

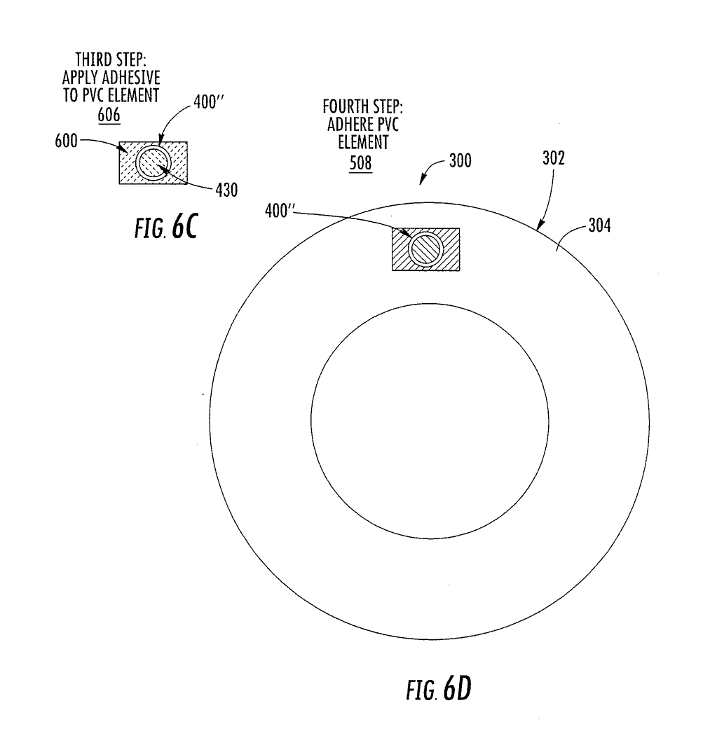

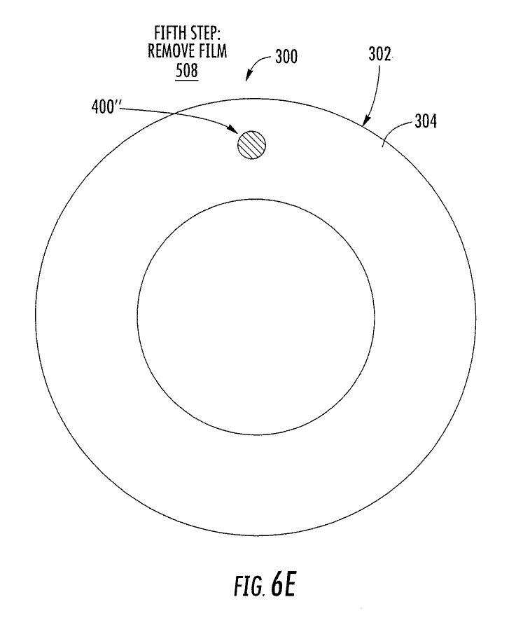

FIGS. 6A-6E illustrate affixing a PVC molded element 400″ to the sidewall 304 of the tire 300. First, the surface of the sidewall 304 of the tire should be cleaned and, optionally, lightly abraded (Step 602). Second, a protective transparent polyester film 600 coated with a transparent, premium grade, controlled-release, low-tack acrylic pressure sensitive adhesive can be applied to the top surface 410 of the PVC molded element 400″ (Step 604). The transparent polyester film 600 can be, for example, 991 high performance transparent film made by Venturetape. Third, an adhesive layer 430 is applied to the bottom surface 420 of the PVC molded element 440″ (Step 606). Next, the adhesive coated bottom surface of the PVC molded element 400″, is applied to the cleaned surface of the sidewall 304 of the tire 300 (Step 608). For this step (Step 608), apply firm pressure to the PVC molded element 400″ to develop a better adhesive contact and improve bond strength with the sidewall 304 of the tire 300. Lastly, the protective transparent polyester film 600 may be removed from the PVC molded element 400″ when in use.

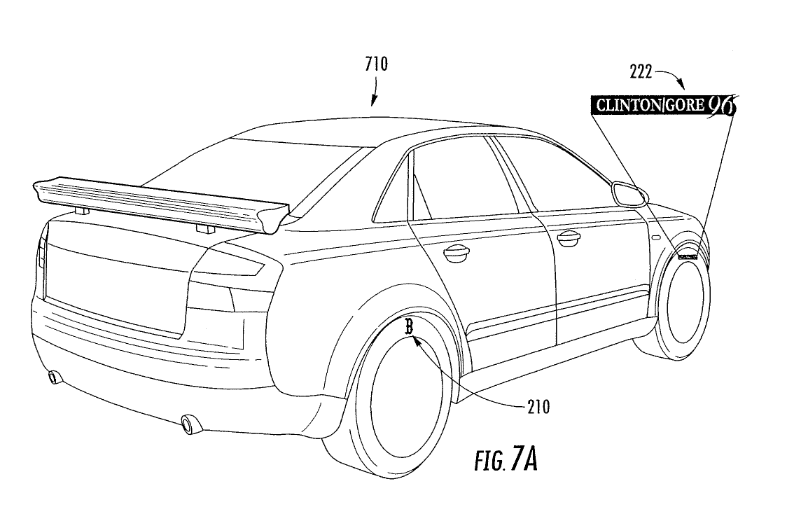

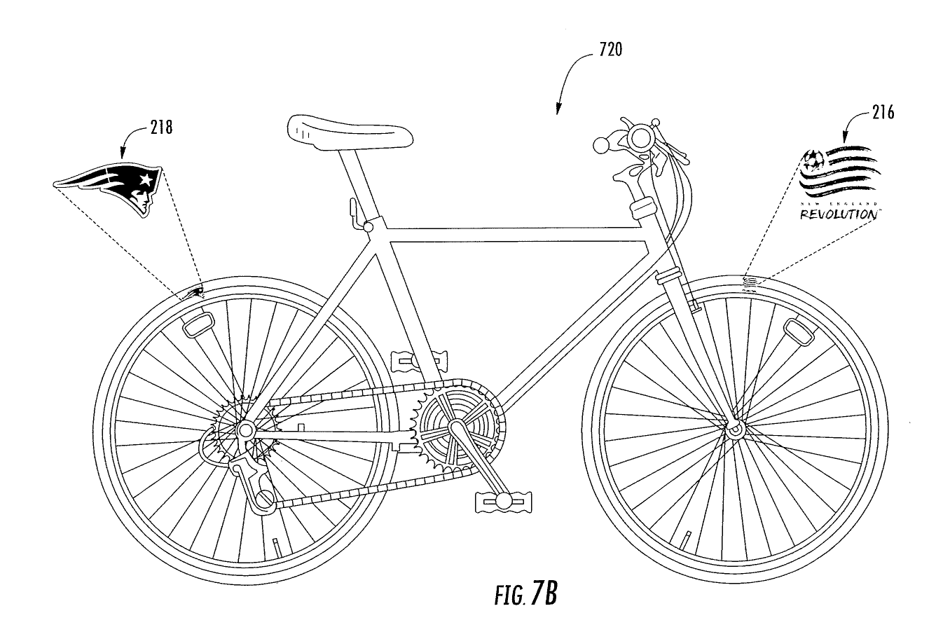

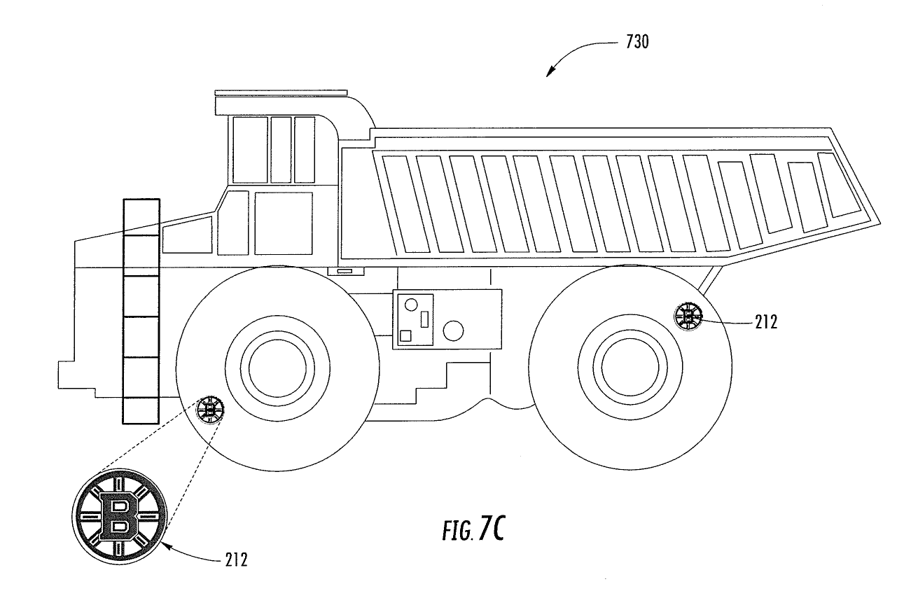

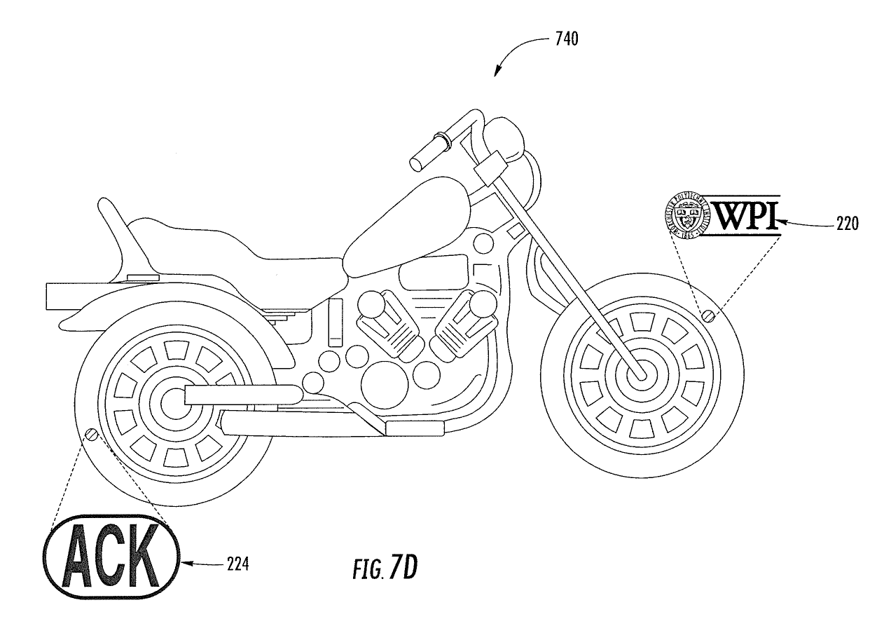

FIGS. 7A-7D illustrate various examples of affixing the PVC molded element 400 to a sidewall 304 of a tire 300. These examples can include automobiles 702, bicycles 704, utility vehicles 706 (e.g. a dump truck, bulldozer, etc.), and motorcycles 706. It should be appreciated by one skilled in the art, that the PVC molded element 400 can be affixed, as described herein, to any tire having a sidewall.

Comprise, include, and/or plural forms of each are open ended and include the listed parts and can include additional parts that are not listed. And/or is open ended and includes one or more of the listed parts and combinations of the listed parts.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A tire, comprising an internal surface and an external surface, the external surface comprising tread and sidewall portions, the tire further comprising: at least one flexible polyvinyl chloride (PVC) molded element disposed entirely on the sidewall portion of the external surface, the PVC molded element including a top surface comprising an exposed area, and a bottom surface comprising and area in contact with the sidewall portion, the bottom surface further comprising an adhesive layer having characteristics that will not degrade when in contact with the sidewall surface portion.

2. The apparatus of claim 1, wherein the exposed top surface area of the PVC molded element further comprises at least one of design and/or information molded there onto.

3. The apparatus of claim 2, wherein the design comprises logos, pictures, and shapes.

4. The apparatus of claim 3, wherein the logos comprise team logos for any professional or collegiate sports team.

5. The apparatus of claim 2, wherein the information comprises colors and text.

6. The apparatus of claim 2, wherein the design and/or information comprises 3-dimensional features.

7. The apparatus of claim 2, wherein the design and/or information comprises a fluorescent material.

8. The apparatus of claim 1, wherein PVC molded element is ultraviolet stable and will not fade when exposed to sunlight.

9. The apparatus of claim 1, wherein PVC molded element is abrasion resistant.

10. The apparatus of claim 1, wherein PVC molded element is resistant to stains and commercial cleaning solvents.

11. The apparatus of claim 1, wherein the adhesive resists the effects of plasticizer migration.

12. The apparatus of claim 1, wherein the adhesive opposes chemical migrations of the chemical composition of the tire.

13. The apparatus of claim 1, wherein the bottom layer further comprises a primer to promote adhesion of the PVC molded element to the tire.

14. The apparatus of claim 1, wherein the bottom layer further comprises a woven, mesh, or knit fabric.

15. A method for affixing a PVC molded element comprising top and bottom surfaces to a sidewall of a tire, the method comprising:
cleaning a portion of the external sidewall surface of the tire; and
applying an adhesive layer to the cleaned sidewall surface portion.

16. The method of claim 15, wherein the step of cleaning a sidewall surface portion of the tire further comprises applying a primer to the cleaned sidewall portion.

17. The method of claim 15, wherein the step of applying an adhesive layer of the PVC molded element to the tire further comprises applying a transparent polyester film to the top surface of a PVC molded element.

18. The method of claim 15, wherein the step of applying an adhesive layer of the PVC molded element to the tire further comprises briefly applying pressure between the PVC molded element and the sidewall surface portion, thereby promoting better adhesive contact and improved bond strength with the sidewall surface portion of the tire.
